(19) United States
(12) Patent Application Publication
(10) Pub. No.: US 2006/0175897 A1
(43) Pub. Date: Aug. 10, 2006

(54) Brake system comprising a plurality of electromagnetic actuators having different properties and method of operating same

(75) Inventor: Russ Ether, Niles, MI (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/053,391

(22) Filed: Feb. 8, 2005

(51) Int. Cl. F16D 55/36; B60T 8/32

(52) U.S. Cl. 303/138; 188/71.5; 188/72.1

(57) ABSTRACT

A brake system (10) having a brake carrier (12), a first EMA (40) mounted on the brake carrier (12) having a first stall force and a first response speed, and a second EMA (50) mounted on the brake carrier (12) having a second stall force and a second response speed different from the first response speed. A method of using such a brake system (10) is also disclosed.

### FIELD OF THE INVENTION

The present invention is directed to a brake system that includes a plurality of electromagnetic actuators having different properties and a method of operating such a brake system, and more specifically, toward a brake system having a first EMA having desirable response characteristics and a second EMA having desirable stall force characteristics and a method of operating such a brake system.

### BACKGROUND OF THE INVENTION

Braking systems using electromagnetic actuators to compress a brake stack are well known. An illustrative electrically actuated braking system is shown in U.S. Pat. No. 4,865,162 to Morris, the contents of which are hereby incorporated by reference, which teaches a plurality of annularly disposed electrically energizable torque motor and roller screw drive mechanisms, sometimes referred to as electromagnetic actuators, or “EMA's.” The EMA's include a piston that is movable against a pressure plate of a wheel and brake assembly to compress a disc brake stack and retard the motion of a vehicle. Such braking systems may be found on a variety of vehicles including aircraft.

One characteristic of such EMA's is the “stall force.” This is the maximum piston output or maximum force applied by the piston against the brake stack. High stall force is important for meeting static brake torque requirements and providing strong braking in emergency situations such as rejected take offs.

Another characteristic of EMA's is dynamic response time. The dynamic response of an EMA refers to the time required to change direction of the EMA piston. An EMA with a fast response can be used with antilock/antiskid brakes which require a rapid modulation of brake force to provide good braking without skidding. Too low a response will prevent an EMA from being used in antiskid operations. Unfortunately, levels of stall force and dynamic response in EMA's are normally inversely related, especially in systems that have size, weight and power consumption limitations.

EMA's that produce a stall force sufficient for emergency operation generally have a dynamic response that is too slow to be used for anti-skid brake operation. This is because the high gear ratio required to produce a high stall force amplifies the motor's reflected inertia and lowers the system's resonant frequency. For these same reasons, systems with a dynamic response suitable for antiskid brake operation generally cannot provide the stall force required in all situations. It would therefore be desirable to provide an electromagnetic braking system that produces a high stall force and has a fast dynamic response.

### SUMMARY OF THE INVENTION

These and other difficulties are addressed by the present invention which comprises, in a first aspect, a brake system that includes a brake carrier, a first EMA mounted on the brake carrier having a first stall force and a first response speed, and a second EMA mounted on the brake carrier having a second stall force and a second response speed different from the first response speed.

Another aspect of the invention comprises a method of compressing a brake stack including stators supported by a torque tube mounted on a carrier. The method involves mounting a first EMA having a first piston having a free end on a first portion of the carrier and mounting a second EMA having a second piston on a second portion of the carrier. The first piston free end is moved against the brake stack and held in a first position to apply a first force to the brake stack. The second piston is moved against the brake stack, and the force of the second piston against the brake stack is modulated to perform an antiskid braking operation on the brake stack.

A further aspect of the invention comprises a brake system that includes a generally circular brake carrier, a first EMA mounted on the brake carrier having a first stall force and a first response speed, and a second EMA mounted on the brake carrier about 180 degrees from the first EMA and having a second stall force less than the first stall force and a second response speed greater than the first response speed, so that the second EMA can be modulated to perform an antiskid braking function. A torque tube is associated with the carrier and has a brake stack mounted thereon. The first and second EMA's each include a piston movable from a first position spaced from the brake stack to a second position contacting the brake stack. A mechanism is provided for maintaining contact between the first piston and the brake stack when the second piston shifts from the first position to the second position.

### BRIEF DESCRIPTION OF THE DRAWINGS

These and other aspects and features of the invention will be better understood after a reading of the following detailed description together with the following drawings wherein:

FIG. 1 is a sectional elevational view of a brake system including a brake stack, a torque tube, a carrier and first and second different EMA's according to a first embodiment of the invention;

FIG. 2 is sectional elevational view of the brake system of FIG. 1 with the piston of the first EMA applying a braking force to the brake stack;

FIG. 3 is a sectional elevational view of the brake system of FIG. 2 showing the piston of the second EMA applying a braking force to the brake stack;

FIG. 4 is a model representing an ideal brake system;

FIG. 5 is sectional elevational view of a brake system including a brake stack, a torque tube, a carrier and first an

FIG. 6 is a sectional elevational view of a brake system including a brake stack, a torque tube, a carrier and first and second EMA's according to a third embodiment of the invention in a first position;

FIG. 7 is a sectional elevational view of the brake system of FIG. 6 in a second position;

FIG. 8 is an elevational view of a plurality of EMA's and a controller mounted on a carrier; and

FIG. 9 is a flow chart illustrating a method of operating a brake system according to an embodiment of the present invention.

### DETAILED DESCRIPTION

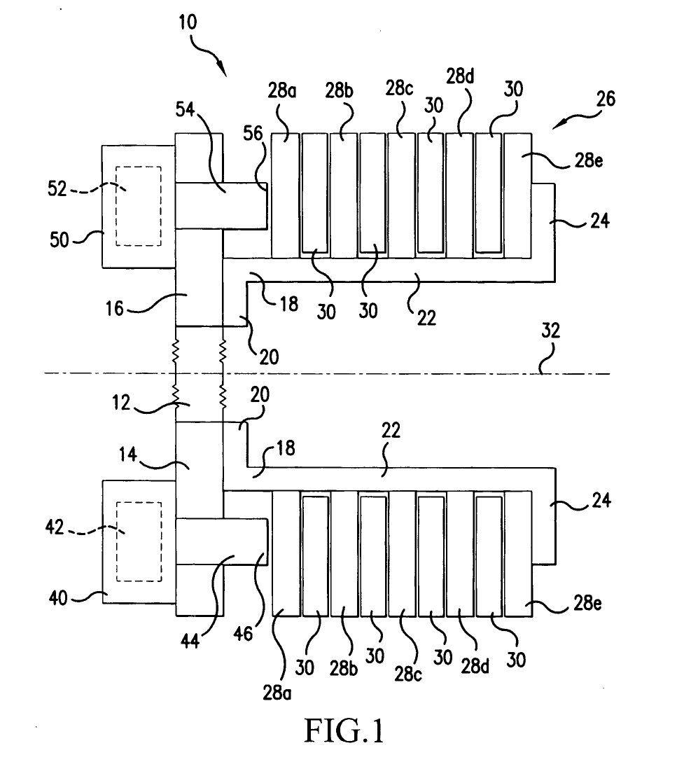

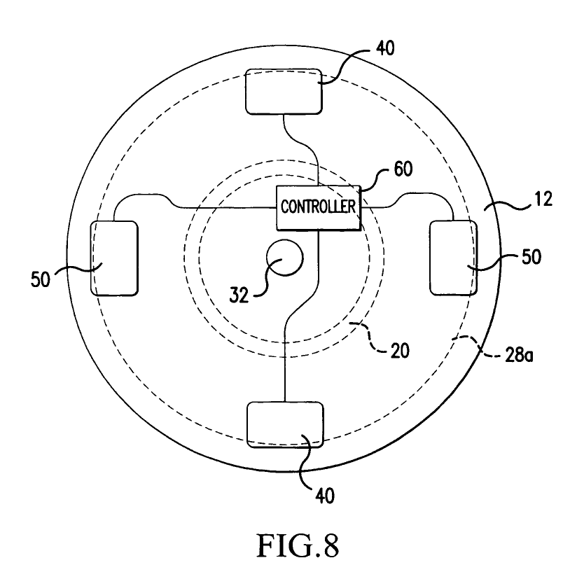

Referring now to the drawings, wherein the showings are for purposes of illustrating embodiments of the invention only and not for the purpose of limiting same, FIG. 1 illustrates, somewhat schematically, a brake system 10 comprising a brake carrier 12 having a first portion 14 and a second portion 16 to which a torque tube 18 is attached. Torque tube 18 includes a first or inner flange 20 attached to carrier 12, a wall 22 projecting from inner flange 20 away from carrier 12, and a second or outer flange 24 projecting from wall 22 in a direction opposite first flange 20. System 10 further includes a brake stack 26, made up of a plurality of stators 28a-28e attach ed to torque tube wall 22 and a plurality of rotors 30 projecting between pairs of adjacent stators 28 and supported by a wheel (not shown) which rotates about centerline 32. Stator 28a closest to carrier 12 is sometimes referred to as a pressure plate. As will be appreciated from FIG. 8, the rotors, stators and carrier are circular in cross section when viewed face on, that is, looking in from the left side of FIG. 1. Inner flange 20 and pressure plate 28a are shown in phantom in FIG. 8.

A first EMA 40 is connected to first portion 14 of carrier 12 and a second EMA 50 is connected to second portion 16 of carrier 12. First EMA 40 includes a drive 42 for driving a piston 44 which piston has a free end 46; second EMA 50 includes a drive 52 for driving a piston 54 which has a free end 56. Controller 60, illustrated in FIG. 8, controls first and second EMA's 40, 50 and any other EMA's mounted on carrier 12. Controller 60 is shown mounted on carrier 12 but could also be located at a distance from the EMA's and connected thereto by suitable wiring. While two EMA's may be provided on certain relatively small aircraft wheels, four or more EMA's would generally be found on larger aircraft. In this case, two first EMA's 40 and two second EMA's 50 would be used and arranged with EMA's 40 spaced about 180 degrees apart from one another as illustrated in FIG. 8.

The first and second EMA's are not identical; rather, first EMA 40 comprises an EMA having a high stall force. This high stall force limits the dynamic response of EMA 40 and makes it less than optimal for antiskid braking uses, differential deceleration control, and other braking applications requiring a rapid response. Second EMA 50 has a dynamic response that makes it suitable for antiskid and other braking operations requiring a rapid response. However, in order to provide such dynamic response, and to keep the size and power consumption of the EMA within acceptable limits, EMA 50 must have a stall force that is lower than what is required in many situations. The present embodiment of the invention is described in terms of an antiskid braking system; however it should be understood that it could be used just as easily in other braking systems requiring both high stall force and rapid braking response.

In operation, therefore, when a braking command is sent to brake system 10, controller 60 causes first EMA 40 to shift from a first position with piston 44 spaced from pressure plate 28a to a second position wherein free end 46 of first piston 44 engages pressure plate 28a and compresses the brake stack 26 to slow a wheel to which it is attached. Under normal operating conditions, all force for compressing brake stack 26 may be provided by first EMA 40. Alternately, second EMA 50 may also be controlled to cause second piston 54 to engage pressure plate 28a and provide supplemental braking force. It is generally preferable to have both first EMA 40 and second EMA 50 provide a portion of braking force under normal operating conditions.

Many aircraft are now equipped with antiskid or antilock brakes which pulsate to modulate the pressure applied by an EMA against a brake stack. As discussed above, first EMA 40 does not have the dynamic response needed to be effectively used with such an antiskid braking system. Second EMA 50 can be modulated in this manner but cannot alone provide the high stall force necessary to slow and stop a wheel, especially when a high braking force is commanded. Therefore, according to an embodiment of the invention, the beginning of a skid may be detected at a time when first EMA 40 is applying significant braking pressure against pressure plate 28a and second EMA 50 is applying a smaller braking force against pressure plate 28a. When the beginning of the skid is detected, controller 60 modulates second EMA 50 to apply rapidly varying pressure against pressure plate 28a to slow the wheel without causing a skid.

Various methods of accomplishing such an antiskid function are known, and these generally comprises applying a braking force until the beginning of a skid is detected, briefly releasing the braking force, and then reapplying the braking force and repeating the above process until no further skid conditions are detected. Beneficially, using this method of an embodiment of the present invention, the antiskid function can be carried out by EMA's which would generally not be able, on their own, to provide the high stall force needed in certain braking situations. Therefore, this embodiment of the present invention provides an antiskid brake system and method that is also capable of providing high stall force.

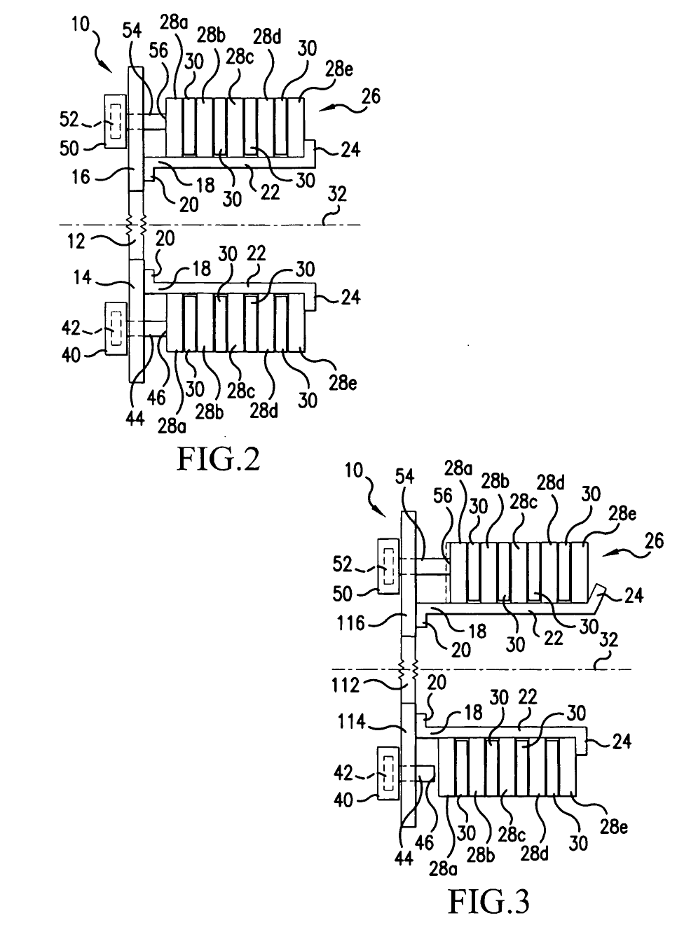

FIG. 2 illustrates first EMA 40 positioned with free end 46 engaging pressure plate 28a at a time that free end 56 of second EMA piston 54 applying little or no pressure against pressure plate 28a. FIG. 3 illustrates, in a highly exaggerated manner for illustration purposes, a problem that may occur when second EMA 50 applies pressure against pressure plate 28a and first EMA 40 is held in a constant position, during an antiskid braking operation, for example. In this situation, the second EMA 50, in applying force against the brake stack 26 actually forces the brake stack away from free end 46 of first piston 44. The original position of pressure plate 28a is illustrated in phantom. In actuality, the brake stack would probably not separate from piston 44, but the braking force provided by piston 44 would be reduced. Thus, for each one unit of pressure applied against brake stack 26 by second EMA 50, the brake stack will see less than one unit of additional force because some of the force from second EMA 50 will reduce the pressure applied by first EMA 40.

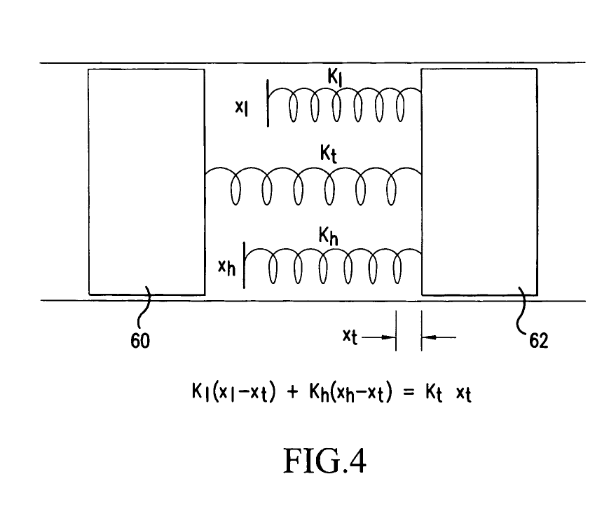

This can be understood mathematically from FIG. 4 which illustrates an idealized model for setting up relevant force equations. FIG. 4 includes a representation 60 of carrier 12 and a representation 62 of outer torque tube flange 24. Kₜ represents the (tension) spring rate of the torque tube. Kₗ and Kₕ represent the (compression) spring rates due to local carrier deflection seen by second EMA 50 (the “l”ow stall force EMA) and first EMA 40 (the “h”igh stall force EMA). X₁ and Xₕ represent the positive piston displacements of EMA 50 and EMA 40, respectively, from the nominal position Xₜ=0 where the EMA pistons are just lightly loading the brake stack to remove free play. Xₜ represents the stretching of the torque tube due to the load produced by Xₗ and Xₕ.

Using this model, one can derive the following mathematical relationship which describes the change in total force on the brake stack (Kₜ)×(Xₜ) resulting from a change in piston displacement of one EMA (EMA 50, for example) while the other EMA, EMA 40, remains at a fixed piston displacement.

$${K}_{l} ( {X}_{l} - {X}_{t} ) + {K}_{h} ( {X}_{h} - {X}_{t} ) = {K}_{t} {X}_{t}$$

$$thus$$

$${X}_{l} = \frac{{K}_{l} {X}_{t} - {K}_{h} {X}_{h} + {K}_{h} {X}_{l} + {K}_{t} {X}_{t}}{{K}_{l}}$$

$$and$$

$$d {X}_{l} = \frac{{K}_{l} + {K}_{h} + {K}_{t}}{{K}_{l}} d {X}_{t} ( for d {X}_{h} = O )$$

$$Now , d F b = d ( {K}_{t} {X}_{t} ) = {K}_{t} d {X}_{t}$$

$$therefore , \\ \frac{d F b}{d {X}_{l}} = \frac{{K}_{t} {K}_{l}}{{K}_{l} + {K}_{h} + {K}_{t}} = \frac{1}{\frac{1}{{K}_{t}} + \frac{1}{{K}_{l}} + \frac{{K}_{h}}{{K}_{t} {K}_{l}}}$$

Ideally, one would prefer that, when increasing the force output contribution from one EMA (while holding the other EMA at a fixed position), the entire increase in force would be seen by the brake stack. However, as illustrated above, the change in total force on the brake stack is always less than the change in force produced by one EMA if the other EMA remains at a fixed position. Thus, in order to maximize the change in brake stack force caused by a change in the position of EMA 50 (with the position of EMA 40 held constant) Kₕ must be minimized relative to Kₜ and K_{l.}

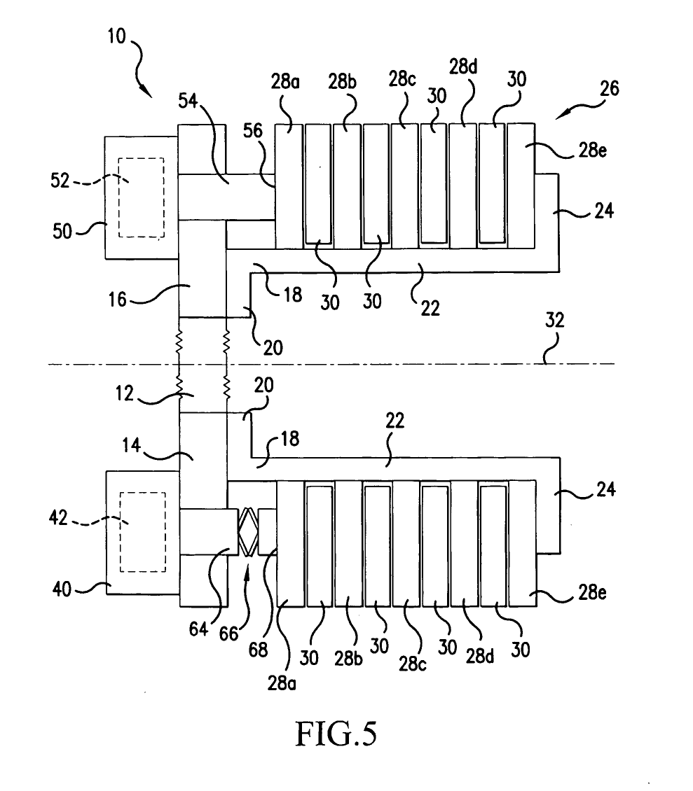

This issue is addressed by the brake system illustrated in FIG. 5 wherein the same reference numerals are used to identify elements common to the earlier embodiments. In this embodiment, EMA 40 is provided with a piston 64 that includes a compression spring 66, Bellville springs or washers, for example, between drive 42 and a free end 68 of the piston. Thus, when piston 64 is moved to a position applying a desired amount of force against pressure plate 28a, spring 66 will be compressed. If the distance between carrier 12 and pressure plate 28a increases, due to a compression of disk stack 26 by second EMA 50, or a deflection of torque tube 18 or a deflection of carrier 12, spring 66 will expand to maintain contact between free end 68 and pressure plate 28a. In this way, the force applied by second EMA 50 is at least partially decoupled from the force applied by first EMA 40.

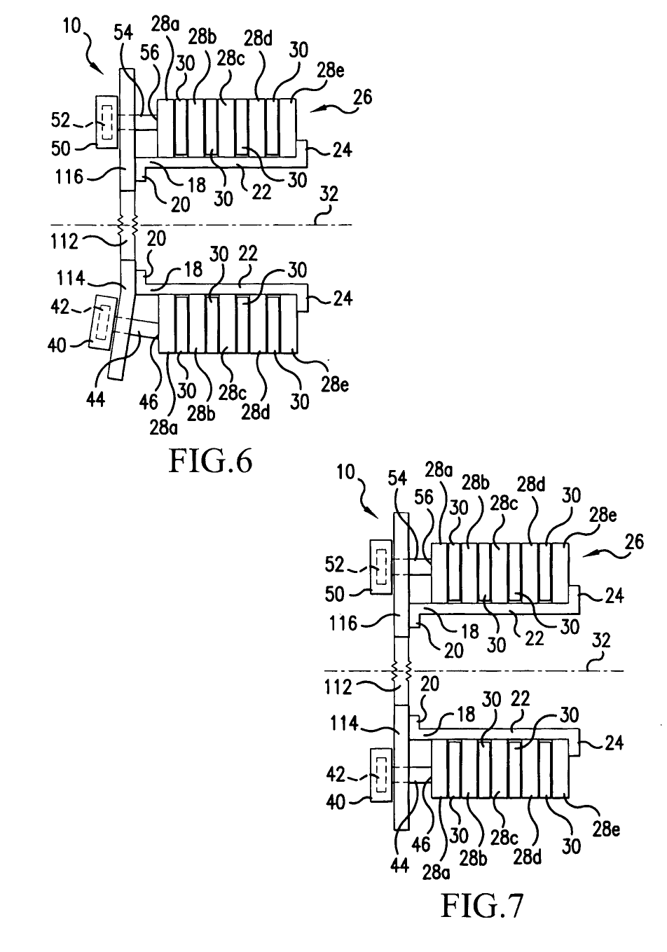

An alternate arrangement for decoupling the force applied by second EMA 50 from the constant force applied by EMA 40 is illustrated in FIGS. 6 and 7. In this embodiment, a carrier 112 is provided that includes a first portion 114 having a first flexibility and a second portion 116 having a second flexibility which is less that the first flexibility. When unstressed, carrier 112 has generally parallel opposite faces. Therefore, a given force applied against first portion 114 will deflect first portion 114 to a greater extent that that same force applied against second portion 116. As illustrated in FIG. 6, again, in a greatly exaggerated manner for illustration purposes, first EMA 40 causes first portion 114 of carrier 112 to deflect away from brake stack 26 when piston 44 applies force against the disk stack 26. FIG. 7 illustrates second EMA 50applying force against brake stack 26 and shifting the disk stack 26 away from second portion 116 of the carrier 112. This movement of brake stack 26 away from second portion 116 does not significantly change the distance between brake stack 26 and first portion 114 of carrier 112 because first portion 114, previously deformed by the pressure of first EMA 40 against brake stack 26, returns toward its original configuration as seen in FIG. 7 when the brake stack 26 moves away from the second portion 114.

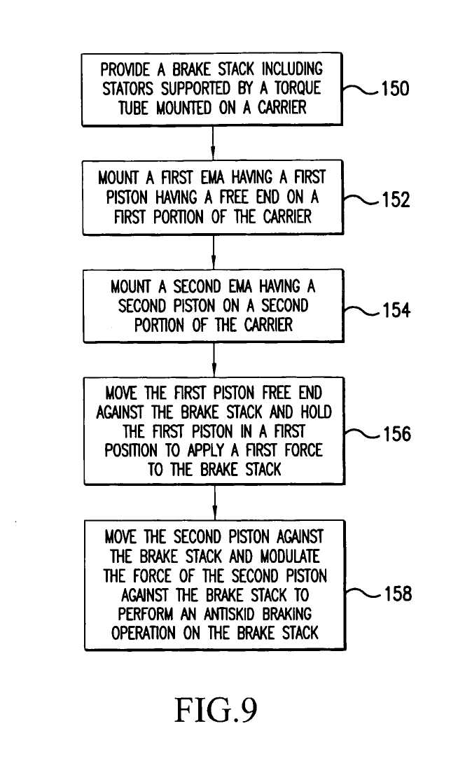

FIG. 9 illustrates a method of operating a braking system according to an embodiment of the present invention which includes a step 150 of providing a brake stack including stators supported by a torque tube mounted on a carrier, a step 152 of mounting a first EMA having a first piston having a free end on a first portion of the carrier and a step 154 of mounting a second EMA having a second piston on a second portion of the carrier. At a step 156, the free end of the first piston is moved against the brake stack and held in a first position to apply a first force to the brake stack. At a step 158, the second piston is moved against the brake stack using a modulated force to perform an antiskid braking operation.

The present invention has been described in terms of several preferred embodiments; however, obvious changes and additions to these embodiments will become apparent to those skilled in the relevant arts upon a reading of the foregoing disclosure. It is intended that all such obvious modifications and additions form a part of the present invention to the extent that they fall within the scope of the several claims appended hereto.

I claim:

1. A brake system comprising:
a brake carrier;
a first EMA mounted on said brake carrier and having a first stall force and a first response speed; and
a second EMA mounted on said brake carrier and having a second stall force and a second response speed different from said first response speed.

2. The brake system of claim 1 including a controller for separately actuating said first EMA and said second EMA.

3. The brake system of claim 1 wherein said first stall force is greater than said second stall force.

4. The brake system of claim 3 wherein said second response speed is greater than said first response speed.

5. The brake system of claim 1 wherein said second EMA is adapted to be modulated in order to perform an antiskid braking function.

6. The brake system of claim 1 wherein said brake carrier is generally circular and said second EMA is spaced from said first EMA by about 180 degrees.

7. The brake system of claim 1 including a third EMA mounted on said brake carrier having a third stall force and a third response speed and a fourth EMA mounted on said brake carrier having a fourth stall force and a fourth response speed.

8. The brake system of claim 7 wherein said third stall force is equal to said first stall force said fourth response speed is equal to said second response speed.

9. The brake system of claim 8 wherein said third EMA is positioned between said first EMA and said second EMA and said fourth EMA is spaced about 180 degrees from said third EMA.

10. The brake system of claim 1 including a torque tube associated with said carrier and a brake stack mounted on said torque tube, wherein said first and second EMA's each include a piston having a free end movable from a first position spaced from said brake stack to a second position contacting said brake stack.

11. The brake system of claim 10 wherein said piston comprises a compression spring that is compressed when said piston moves from said first position to said second position.

12. The brake system of claim 10 wherein said first EMA is mounted on a first portion of said carrier and said second EMA is mounted on a second portion of said carrier, said first portion deflecting away from said brake stack a first amount upon application of a given force and said second portion deflecting away from said brake stack a second amount upon application of said given force, wherein said first amount is greater than said second amount.

13. The brake system of claim 10 including means for maintaining contact between said first piston and said brake stack when said second piston shifts from said first position to said second position.

14. The brake system of claim 10 including biasing means for biasing said first piston free end toward said brake stack when said first piston is in said second position.

15. A method of compressing a brake stack including stators supported by a torque tube mounted on a carrier comprising the steps of:
mounting a first EMA having a first piston having a free end on a first portion of the carrier;
mounting a second EMA having a second piston on a second portion of the carrier;
moving the first piston free end against the brake stack and holding the first piston in a first position to apply a first force to the brake stack; and
moving the second piston against the brake stack and modulating the force of the second piston against the brake stack to perform an antiskid braking operation on the brake stack.

16. The method of claim 15 including the additional step of at least partially decoupling the first force from the second force.

17. The method of claim 16 wherein said step of at least partially decoupling the first force from the second force comprises the step of using said first force to compress a resilient element.

18. The method of claim 16 wherein said step of at least partially decoupling the first force from the second force comprises the step of biasing the free end toward the brake stack.

19. The method of claim 16 wherein said step of at least partially decoupling the first force from the second force comprises the step of biasing the carrier first portion toward the brake stack when the first piston is in the first position.

20. A brake system comprising:
a generally circular brake carrier;
a first EMA mounted on said brake carrier and having a first stall force and a first response speed;
a second EMA mounted on said brake carrier about 180 degrees from said first EMA and having a second stall force less than said first stall force and a second response speed greater than said first response speed, whereby said second EMA can be modulated to perform an antiskid braking function;
a torque tube associated with said carrier and a brake stack mounted on said torque tube;
said first and second EMA's each including a piston movable from a first position spaced from said brake stack to a second position contacting said brake stack; and
means for maintaining contact between said first piston and said brake stack when said second piston shifts from said first position to said second position.
